(19) United States
(12) Patent Application Publication
(10) Pub. No.: US 2005/0232362 A1
(43) Pub. Date: Oct. 20, 2005

(54) High-speed image compression apparatus using last non-zero detection circuit

(75) Inventor: Ki Taik Lee, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 11/074,335

(22) Filed: Mar. 7, 2005

(30) Foreign Application Priority Data
Apr. 6, 2004 (KR) 10-2004-23537

(51) Int. Cl. H04N 7/12

(52) U.S. Cl. 375/240.23; 375/240.03

(57) ABSTRACT

Disclosed is a high-speed image compression apparatus using a last non-zero detection circuit. A memory stores data corresponding to a result of a quantization operation that quantizes an input. A last non-zero searcher connected to the memory searches for a last non-zero position while the quantization result data is written to the memory, and outputs last non-zero position data. A VLC (Variable Length Coder) finds a pattern from the quantization result data and the last non-zero position data, searches for a variable length code mapped to the pattern, packs the variable length code in a unit of a word, and outputs a compressed stream. The high-speed image compression apparatus can reduce a variable length coding time and can rapidly operate the overall compression system according to a reduced variable length coding time, thereby increasing a frame rate.

### BACKGROUND OF THE INVENTION

1. Field of the Invention

The present invention relates generally to a high-speed image compression apparatus using a last non-zero detection circuit, and more particularly to a high-speed image compression apparatus using a last non-zero detection circuit that can implement a high-speed VLC (Variable Length Coder) by adding a last non-zero detection function to improve the performance of an image compression system.

2. Description of the Related Art

Among lossless compression techniques for eliminating data redundancy using statistical methods, variable length coding has been adopted for image compression in international standards such as JPEG (Joint Photographic Experts Group), MPEG (Moving Picture Experts Group), and H.263.

Conventionally, an image compression system includes a DCT (Discrete Cosine Transformer), a quantizer, a VLC (Variable Length Coder), etc. The DCT transforms a spatial domain image into a frequency domain image. The quantizer reduces frequency domain data by means of a lossy compression technique. The VLC carries out a lossless compression operation on the quantization result data.

An image compression operation is carried out in units of blocks that consist of 64 pixels, respectively. That is, one frame is divided into a plurality of blocks. DCT, quantizer, and VLC operations are repeatedly performed on the plurality of blocks, such that compressed data is obtained for the entire image.

Because non-zero values in frequency domain data of 8×8 pixels are mainly concentrated on a low-frequency domain according to image characteristics, a zigzag scan starts with DC (Direct Current) components first and proceeds to a high-frequency domain last, and re-orders the data such that variable length coding can be carried out according to the re-ordering. The variable length coding carries out a scan according to the re-ordering, finds a specific data pattern, and maps the found specific data pattern to a codebook. In a process for finding a non-zero value while performing the scan, calculating a run of pixels up to the found non-zero value, and determining whether the found non-zero value is the last non-zero value within a given block, the data pattern is expressed by a set consisting of “Run”, “Value”, and “Last” parameters.

FIG. 1 is a block diagram illustrating conventional image compression flow. As illustrated in FIG. 1, a conventional functional block for-image-compression includes a DCT (Discrete Cosine Transformer) 1, a DCT data memory 2, a quantizer 3, a quantizer data memory 4, and a VLC (Variable Length Coder) 5, etc.

As described above, the entire image is divided into a plurality of blocks that consist of 8×8 pixels, respectively. After each block passes through the DCT 1, the quantizer 3, and the VLC 5, a compressed stream is produced. One block is stored in a memory as illustrated in FIG. 2. The DCT data memory 2 and the quantizer data memory 4 as illustrated in FIG. 1 are based on the memory format as illustrated in FIG. 2.

The DCT 1 transforms a spatial domain image into a frequency domain image. Generally, in the image, the number of low-frequency components is larger than the number of high-frequency components. Because information is concentrated on the low-frequency components when the spatial domain image is transformed into the frequency domain image, compression can be easily performed. Discrete-cosine-transformation result data from the DCT 1 is stored in the DCT data memory 2, and is quantized pixel by pixel. Quantization is a lossy compression method for leaving only image data that the human eye can perceive and discarding the remaining image data. Because the high-frequency components do not affect the image that the human eye perceives, the low-frequency components are mainly left, thereby improving the compression rate. The VLC 5 carries out a lossless compression operation on the quantization result data using statistical methods to produce a final compressed stream.

FIG. 3 is a block diagram illustrating a conventional VLC (Variable Length Coder). As illustrated in FIG. 3, the conventional VLC 5 includes a pattern finder 51, a last non-zero searcher 52, a codebook searcher 53, and a packer 54.

The pattern finder 51 finds a pattern having three parameters of “Run”, “Value”, and “Last” from quantization result data. Here, the “Value” parameter is a current pixel value, the “Run” parameter is the number of previous pixels with consecutive zero values, and the “Last” parameter indicates whether a non-zero value is absent after the current pixel.

The pattern finder 51 sequentially reads values from the quantizer data memory 4 to create one pattern. When the read value is 0, the pattern finder 51 increments a run count. However, when the read value is non-zero, the “Value” parameter is set to the read value. Then, when subsequent pixel values are all 0, the “Last” parameter is set to 1. However, when subsequent pixel values are all non-zero, the “Last” parameter is set to 0. This pattern creation process is iterated. The created pattern is inputted into the codebook searcher 53. The codebook searcher 53 searches for a variable length code mapped to the pattern. The variable length code configures a table preset according to an image compression scheme. In the table, a corresponding pattern is mapped to a short code when the number of pattern occurrences is large, and a corresponding pattern is mapped to a long code when the number of pattern occurrences is small. According to the table, statistical compression is performed. The packer 54 creates a final compressed stream by packing bits of variable length codes in units of words.

In the course of finding the pattern, data is reordered by a zigzag scan for coding in alternating directions. As most of the high-frequency components are set to 0, blocks are encoded by means of a small number of patterns.

The “Last” parameter in the data pattern indicates whether a current pixel in the zigzag scan has the last non-zero value. The “Last” parameter of 1 indicates that subsequent pixel values are all 0. The “Last” parameter cannot be determined by only a current pixel value, but can be determined after remaining pixels are inspected. When the last pixel corresponding to Pixel Index 63 rather than the current pixel is inspected, the last pattern is created. Accordingly, this process is inefficient. To address this problem, the last non-zero searcher 52 is conventionally used, as illustrated in FIG. 3. The last non-zero searcher 52 carries out an operation for searching for a position of the last non-zero pixel that starts with Pixel Index 63 in inverse zigzag scan order as illustrated in FIG. 5. When the last non-zero searcher 52 searches for the last non-zero pixel and notifies the pattern finder 51 of the position of the last non-zero pixel, the pattern finder 51 can terminate a process for finding a pattern in the position of the last non-zero pixel.

The operation for reading quantization result data serving as a VLC input from the quantizer data memory 4 in inverse scan order serves only to identify the position of the last non-zero pixel. If the position of the last non-zero pixel can be identified in advance, a coding operation can be immediately performed in scan order without performing the above-described read operation in inverse scan order. After an operation of the DCT is carried out, most of the pixels belong to a low-frequency domain according to image characteristics. Because a significant time period is required to find a non-zero pixel in inverse scan order, a VLC operation is significantly delayed.

FIG. 6 illustrates an example of Pixel Index 15 with the last non-zero value. As illustrated in FIG. 6, the last non-zero pixel in scan order corresponds to Pixel Index 15. To find the last non-zero pixel, 50 memory accesses in inverse scan order are required, starting with Pixel Index 63, and then a coding operation is performed that starts with Pixel Index 0 in scan order. A scan for actual coding requires approximately 15 cycles, while an inverse scan for finding the last non-zero pixel requires approximately 50 cycles. Accordingly, the above-described operation is inefficient.

FIG. 7 is a graph illustrating the number of blocks in which the last non-zero value is present in a corresponding pixel index. In FIG. 7, pixel indexes having the last non-zero value in VLC (Variable Length coder) input data of the conventional image are arranged in scan order. It can be seen from FIG. 7 that the last non-zero values are concentrated in a range of Pixel Indexes 0 to 9 among 64 pixels.

FIG. 8 is a graph illustrating a percentage of the accumulated number of blocks in which the last non-zero value is present in a corresponding pixel index. It can be seen from FIG. 8 that the last non-zero values are concentrated in a range of Pixel Indexes 0 to 31 corresponding to half of 64 pixels in approximately 80% of the blocks. Additionally, it can be seen from FIG. 8 that approximately 80% of the blocks consume approximately 50% or more of the VLC operation time to find the last non-zero pixels.

Because an inverse scan process serving as a preparation process for encoding conventionally increases time delay, there is a problem in that the increased time delay serves as a factor causing an inefficient operation in implementing a high-speed VLC.

### SUMMARY OF THE INVENTION

Therefore, the present invention has been made in view of the above and other problems, and it is an object of the present invention to provide a high-speed image compression apparatus using a last non-zero detection circuit that can implement a high-speed VLC (Variable Length Coder) by adding a last non-zero detection function to improve the performance of an overall image compression system.

In accordance with an aspect of the present invention, the above and other objects can be accomplished by a high-speed image compression apparatus using a last non-zero detection circuit, comprising: a memory for storing data corresponding to a result of a quantization operation that quantizes an input; a last non-zero searcher connected to the memory for searching for a last non-zero position while the quantization result data is written to the memory, and outputting last non-zero position data; and a VLC (Variable Length Coder) for finding a pattern from the quantization result data and the last non-zero position data, searching for a variable length code mapped to the pattern, packing the variable length code in a unit of a word, and outputting a compressed stream.

Preferably, the last non-zero searcher comprises: a scan order converter for performing a conversion into an address corresponding to zigzag scan order in response to an address signal necessary for converting access order for the memory, and outputting scan position data; a non-zero detector for outputting a detection result value in response to a data signal necessary for detecting a non-zero position; a comparator for outputting a comparison result value in response to the scan position data and the last non-zero position data; a logic operation element for carrying out a logic operation on the detection result value outputted from the non-zero detector, the comparison result value outputted from the comparator, and a write signal necessary for storing only data to be used in the VLC; a multiplexer for receiving and multiplexing a logic operation result value outputted from the logic operation element, the scan position data, and the last non-zero position data; and a non-zero position register for selecting and updating a current write address in response to a multiplexing result value outputted from the multiplexer, and outputting the last non-zero position data to the comparator, the multiplexer, and the VLC.

Preferably, the VLC comprises: a pattern finder for finding the pattern from the last non-zero position data and the quantization result data; a codebook searcher for searching for the variable length code mapped to the pattern; and a packer for packing bits of the variable length code in the word unit, and outputting the compressed stream.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating conventional image compression flow;

FIG. 2 illustrates the configuration of an 8×8 block memory;

FIG. 3 is a block diagram illustrating a conventional VLC (Variable Length Coder);

FIG. 4 illustrates zigzag scan order for an 8×8 block memory;

FIG. 5 illustrates an inverse scan in a last non-zero search;

FIG. 6 illustrates an example of Pixel Index 15 with the last non-zero value;

FIG. 7 is a graph illustrating the number of blocks in which the last non-zero value is present in a corresponding pixel index;

FIG. 8 is a graph illustrating a percentage of the accumulated number of blocks in which the last non-zero value is present in a corresponding pixel index;

FIG. 9 is a block diagram illustrating the configuration of a VLC (Variable Length Coder) in accordance with one embodiment of the present invention;

FIG. 10 is a block diagram illustrating a last non-zero detector in accordance with the present invention; and

FIGS. 11A and 11B illustrate an example of comparing the time required to perform the inventive compression with that of the conventional compression.

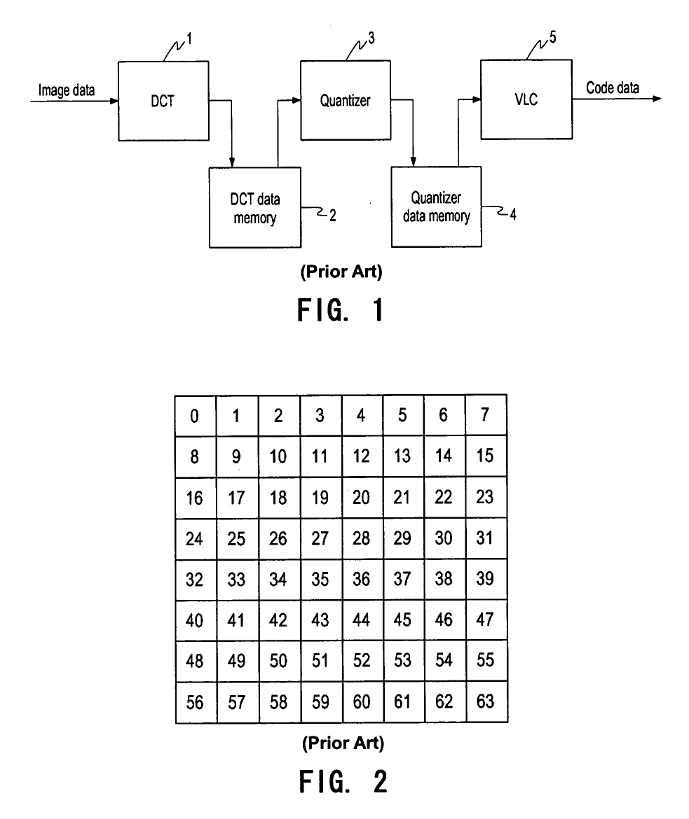

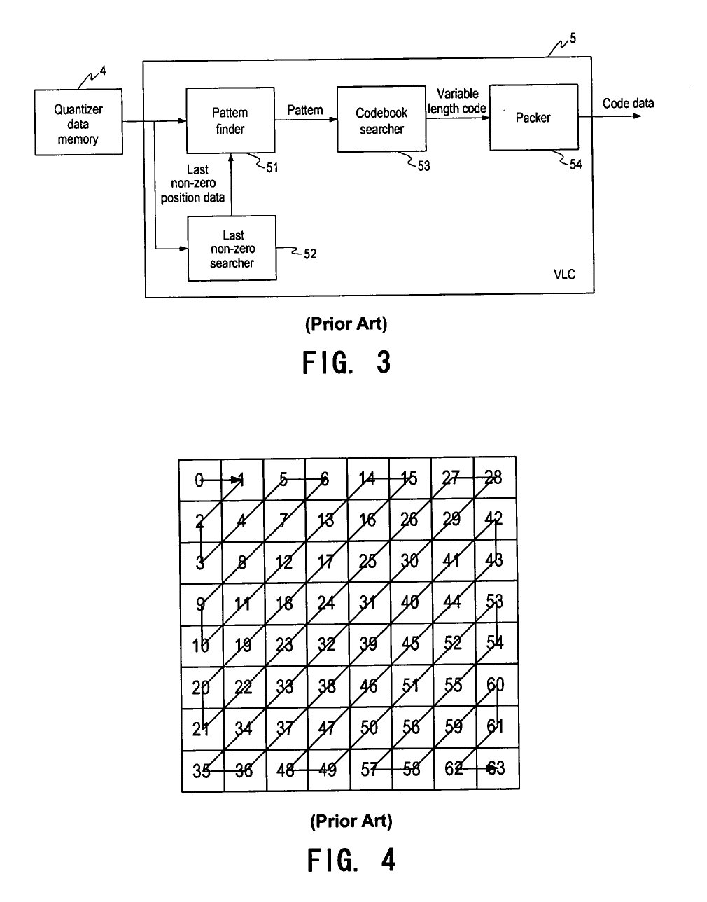

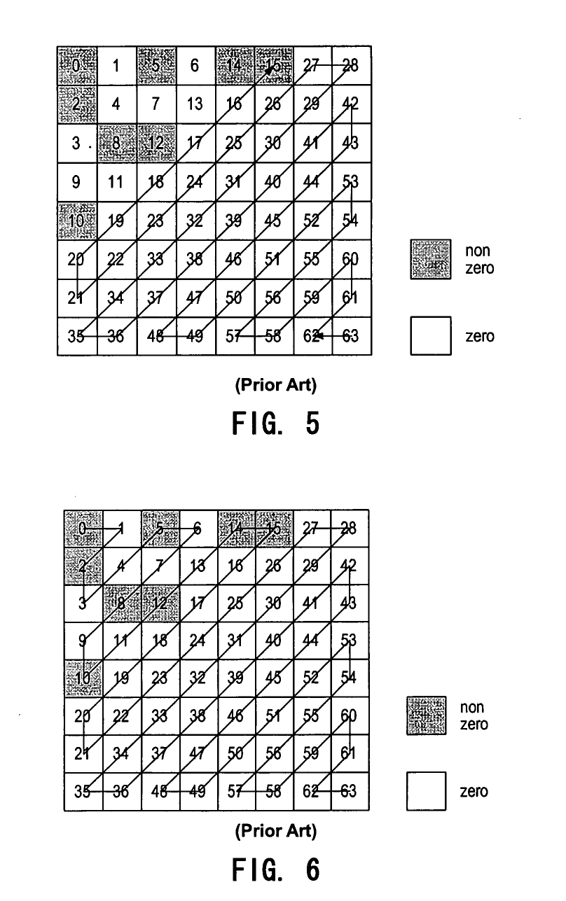

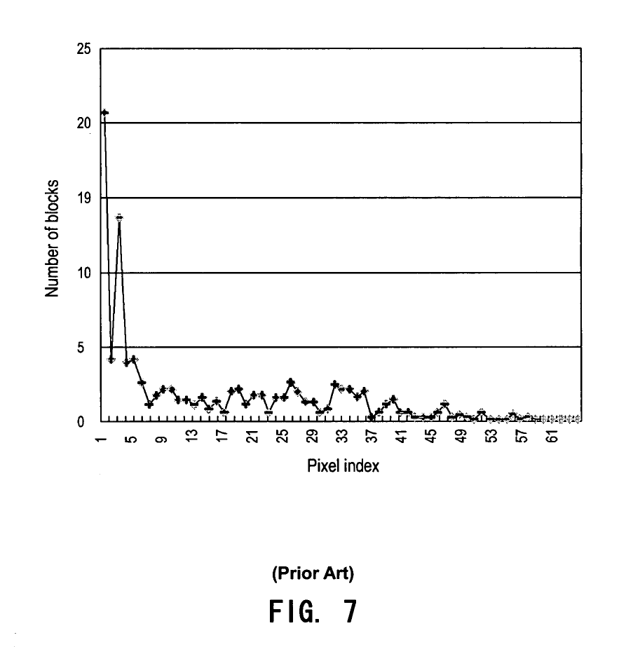

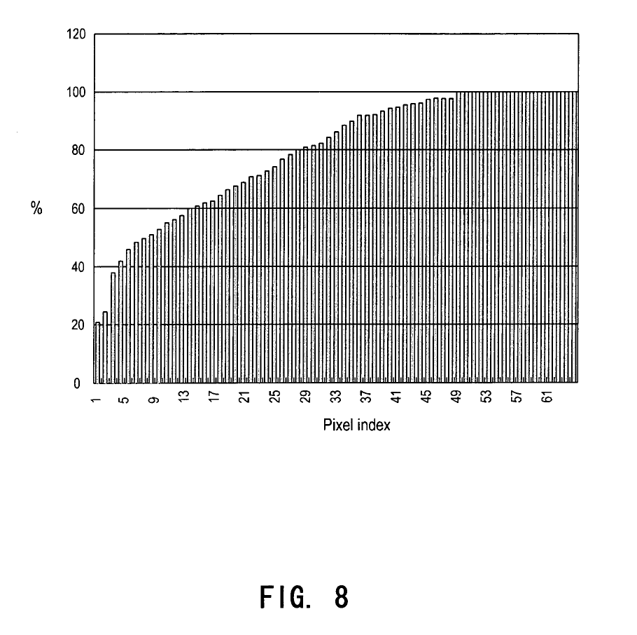

### DESCRIPTION OF THE PREFERRED EMBODIMENTS

Preferred embodiments of the present invention will be described in detail herein below with reference to the annexed drawings.

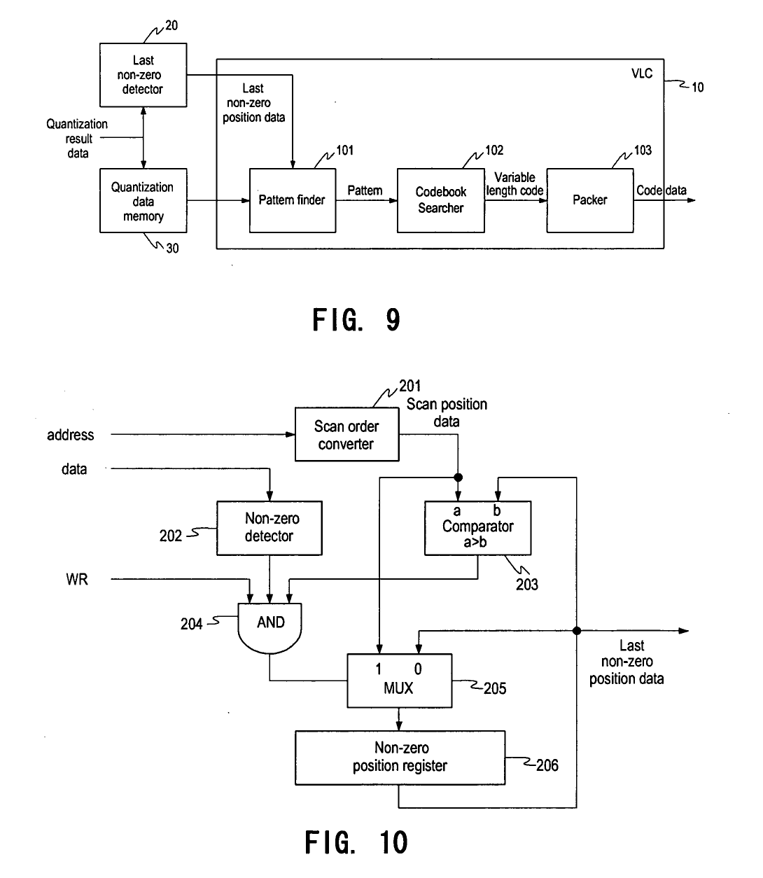

FIG. 9 is a block diagram illustrating the configuration of an image compression system in accordance with the present invention. As illustrated in FIG. 9, the system in accordance with the present invention includes a VLC (Variable Length Coder) 10, a last non-zero detector or searcher 20, and a quantizer data memory 30.

The VLC 10 includes a pattern finder 101, a codebook searcher 102 and a packer 103. It can be seen from FIG. 9 that the VLC 10 in accordance with the present invention is similar to the conventional VLC, but is separated from the last non-zero searcher 20. Additionally, It can be seen from FIG. 9 that data corresponding to a result of quantization is simultaneously inputted into the last non-zero searcher 20 and the quantizer data memory 30.

The last non-zero searcher 20 separated from the VLC 10 is connected to an input terminal of the quantizer data memory 30.

While data serving as an input of the VLC 10 is written to the quantizer data memory 30 in accordance with the present invention, a last non-zero position is searched for and data of the retrieved position is used in the VLC 10. The VLC 10 creates a pattern without performing a last non-zero search to start an encoding operation, thereby reducing an operation time of the VLC 10.

As compared with the operation time of the conventional VLC that performs a last non-zero search, the operation time of the VLC in accordance with the present invention can be reduced. That is, the last non-zero position is detected while the quantization result data is written to the quantizer data memory 30. When quantization is completed, the last non-zero position is detected. The VLC 10 does not need to additionally consume a time period for searching for the last non-zero position.

In a state in which the quantization result data is completely stored and simultaneously the last non-zero position is detected, the quantization result data and the last non-zero position data are transferred to the pattern finder 101.

FIG. 10 is a block diagram illustrating the last non-zero detector 20 in accordance with the present invention. As illustrated in FIG. 10, the last non-zero detector 20 in accordance with the present invention includes a scan order converter 201, a non-zero detector 202, a comparator 203, an AND gate 204, a multiplexer 205, and a non-zero position register 206.

The last non-zero detector 20 uses address, data, and WR (Write) signals to access a quantizer. An address signal is used to convert memory access order into zigzag scan order. The data signal is used to detect a non-zero position. The WR signal is used to extract a pixel to be written, that is, only data to be used in the VLC 10.

In response to the address signal, the scan order converter 201 performs a conversion into an address corresponding to zigzag scan order, and outputs scan position data. As described above, the scan order converter 201 converts conventional memory addresses into addresses corresponding to zigzag scan order.

In response to the data signal, the non-zero detector 202 outputs a detection result value. At this time, the non-zero detector 202 outputs 1 when the data signal is non-zero. However, the non-zero detector 202 outputs 0 when the data signal is 0.

The comparator 203 simultaneously receives a value of the scan position data, denoted by “a”; from the scan order converter 201, and an output value, denoted by “b”, indicating the last non-zero position from the non-zero position register 206 and then outputs a comparison result value. The comparator 203 compares the two values a and b. The comparator 203 outputs a value of 1 if a>b. However, the comparator 203 outputs a value of 0 if a≦b.

In response to the WR signal, the detection result value outputted from the non-zero detector 202, and the comparison result value outputted from the comparator 203, the AND gate 204 outputs a logic operation result value. That is, the logic operation result value outputted from the AND gate 204 serves as a selection signal of the multiplexer 205.

The multiplexer 205 multiplexes the selection signal, the scan position data, and the value outputted from the non-zero position register 206, and then outputs a multiplexing result value.

The non-zero position register 206 transfers a signal indicating the last non-zero position outputted from the multiplexer 205 to the comparator 203, the multiplexer 205, and the pattern finder 101.

The last non-zero detector constructed as described above performs the following operation.

Initially, the non-zero position register 206 is initialized to 0, and is updated whenever data is written to the quantizer data memory 30. The update operation is performed when the comparison result value of the comparator 203 is 1 or the current value is larger than the previous value in scan order, data corresponding to a value of 1 outputted from the non-zero detector 202 is non-zero, and a write operation corresponding to a WR signal of 1 is performed. When the three requirements described above are satisfied, the AND gate 204 outputs 1. If the multiplexer 205 outputs 1, the non-zero position register 206 selects and updates a current write address. Otherwise, the previous value is maintained.

When the write operation in the quantizer data memory 30 is completed, the non-zero position register 206 outputs a value. The prior art requires a significant time period to obtain the value outputted from the non-zero position register 206. The VLC 10 uses the value outputted from the non-zero position register 206.

Therefore, because the VLC 10 can identify the last non-zero position before performing an encoding operation, the encoding operation can be carried out quickly.

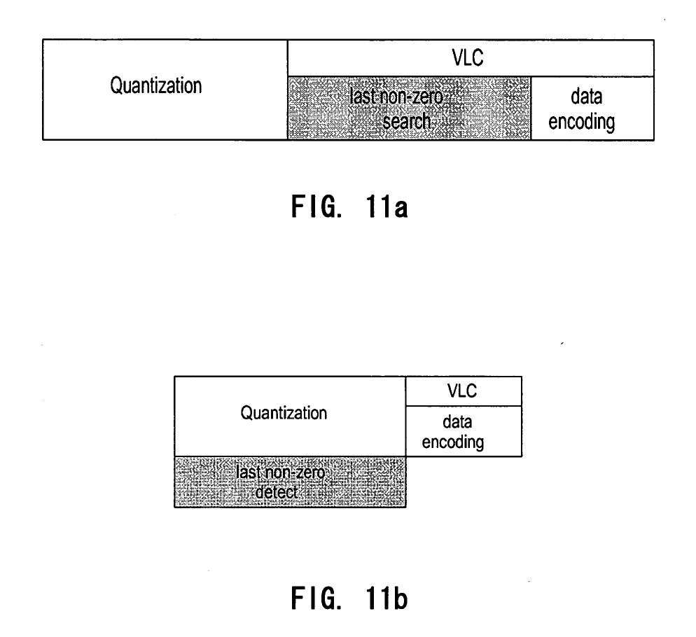

FIGS. 11A and 11B illustrate an example of comparing the time required to perform the inventive compression and the conventional compression. Referring to FIGS. 11A and 11B, a VLC (Variable Length Coder) according to the prior art performs a last non-zero search after quantization and needs a predetermined time period for the last non-zero search before variable length coding. Accordingly, the variable length coding is delayed by the time period required for the last non-zero search or detection. However, a VLC (Variable Length Coder) in accordance with the present invention can encode data without time delay because the last non-zero search or detection is performed during quantization, thereby reducing a variable length coding time and an overall compression time of a compression system.

As apparent from the above description, the present invention provides a high-speed image compression apparatus using a last non-zero detection circuit that can reduce a variable length coding time and that can rapidly operate the overall compression system according to a reduced variable length coding time, thereby increasing a frame rate.

The present invention can be applied to low-power mobile video terminals using a VLC (Variable Length Coder)-based image compression technique such (Joint Photographic Experts Group), MPEG (Moving Picture Experts Group), and H.263.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A high-speed image compression apparatus using a last non-zero detection circuit, comprising:
a memory for storing data corresponding to a result of a quantization operation that quantizes an input;
a last non-zero searcher connected to the memory for searching for a last non-zero position while the quantization result data is written to the memory, and outputting last non-zero position data; and
a VLC (Variable Length Coder) for finding a pattern from the quantization result data and the last non-zero position data, searching for a variable length code mapped to the pattern, packing the variable length code in a unit of a word, and outputting a compressed stream.

2. The high-speed image compression apparatus of claim 1, wherein the last non-zero searcher comprises:
a scan order converter for performing a conversion into an address corresponding to zigzag scan order in response to an address signal necessary for converting access order for the memory, and outputting scan position data;
a non-zero detector for outputting a detection result value in response to a data signal necessary for detecting a non-zero position;
a comparator for outputting a comparison result value in response to the scan position data and the last non-zero position data;
a logic operation element for carrying out a logic operation on the detection result value outputted from the non-zero detector, the comparison result value outputted from the comparator, and a write signal necessary for storing only data to be used in the VLC;
a multiplexer for receiving and multiplexing a logic operation result value outputted from the logic operation element, the scan position data, and the last non-zero position data; and
a non-zero position register for selecting and updating a current write address in response to a multiplexing result value outputted from the multiplexer, and outputting the last non-zero position data to the comparator, the multiplexer, and the VLC.

3. The high-speed image compression apparatus of claim 1, wherein the VLC comprises:
a pattern finder for finding the pattern from the last non-zero position data and the quantization result data;
a codebook searcher for searching for the variable length code mapped to the pattern; and
a packer for packing bits of the variable length code in the word unit, and outputting the compressed stream.

4. The high-speed image compression apparatus of claim 2, wherein the VLC comprises:
a pattern finder for finding the pattern from the last non-zero position data and the quantization result data;
a codebook searcher for searching for the variable length code mapped to the pattern; and
a packer for packing bits of the variable length code in the word unit, and outputting the compressed stream.
